(19) United States
(12) Patent Application Publication
(10) Pub. No.: US 2022/0197287 A1
(43) Pub. Date: Jun. 23, 2022

(54) MAP-BASED STOP POINT CONTROL

(71) Applicant: GM GLOBAL TECHNOLOGY OPERATIONS LLC, Detroit, MI (US)

(72) Inventors: Benjamin L. Williams, South Lyon, MI (US); Shefali P. Bhavsar, Walled Lake, MI (US); Mason D. Gemar, Cedar Park, TX (US)

(21) Appl. No.: 17/130,274

(22) Filed: Dec. 22, 2020

(51) Int. Cl. G05D 1/02; G01C 21/00; B60W 10/04; B60W 10/18; B60W 10/20

(52) U.S. Cl. CPC G05D 1/0212; G01C 21/3815; G05D 1/0278; B60W 10/04; B60W 2710/20; B60W 10/20; G05D 2201/0213; B60W 2710/18; B60W 10/18

(57) ABSTRACT

A system and method for automated vehicle control includes referencing map based attributes relevant to an ego vehicles GPS coordinates, establishing control points based upon the map based attributes, and controlling the ego vehicle to the control points with at least one of a steering system, braking system, and powertrain system.

### INTRODUCTION

This disclosure is related to situational awareness and automated vehicle control of road vehicles.

Perception systems are known to monitor the region surrounding a vehicle for improving vehicle situational awareness, for example forward and rear range, range-rate and vision systems. Such perception systems may be utilized in providing operator alerts and control inputs related to infrastructure and objects, including other vehicles. Such systems may be enablers in various levels of automated vehicle controls, for example adaptive cruise controls, assisted parking, lane keeping, and self-navigation.

Perception systems and mapping systems may be used in conjunction with other technologies such as GPS, odometry, and inertial measurements for vehicle localization, and other base map layers including feature and attribute data. Such technology combinations are useful in trip routing and higher levels of automated vehicle controls.

Higher levels of vehicle automation substantially rely upon reliable environmental perception of infrastructure and objects. However, even the best trained systems may be unable to adequately characterize the environment in all situations or conditions required for certain vehicle automation functions.

### SUMMARY

In one exemplary embodiment, a method for automated driving may include real time mapping driving scene attributes with an ego vehicle perception system and settling ego vehicle control points based upon the real time mapping. When real time mapping is indeterminate with respect to scene attributes needed for settling ego vehicle control points, base map data may be referenced for predetermined attributes and ego vehicle control points settled based upon the predetermined attributes from the base map data. At least one of a steering system, a braking system and a powertrain system is controlled to control the ego vehicle to the ego vehicle control points.

In addition to one or more of the features described herein, referencing base map data for predetermined attributes may include referencing base map data relevant to GPS coordinates of the ego vehicle.

In addition to one or more of the features described herein, settling ego vehicle control points based upon the predetermined attributes from the base map data may include arbitrating among the predetermined attributes to select a preferred one of the predetermined attributes and settling one ego vehicle control point based on the preferred one of the predetermined attributes.

In addition to one or more of the features described herein, arbitrating among the predetermined attributes may include evaluating existence and confidence levels of the predetermined attributes in a predetermined sequence and selecting a first acceptable predetermined attribute as the preferred one of the predetermined attributes.

In addition to one or more of the features described herein, arbitrating among the predetermined attributes may include evaluating existence and confidence levels of the predetermined attributes and selecting as the preferred one of the predetermined attributes the predetermined attribute having the highest confidence level.

In addition to one or more of the features described herein, the predetermined attributes may include pavement markings, a sidewalk, a road edge curvature, an intersecting road segment, an intersection lane segment, and a perpendicular road edge.

In addition to one or more of the features described herein, pavement markings may include a stop line, a yield line and a crosswalk.

In addition to one or more of the features described herein, the ego vehicle perception system may include a vision system.

In addition to one or more of the features described herein, the ego vehicle perception system may further include at least one of a radar system, a lidar system, and an ultrasonic system.

In addition to one or more of the features described herein, referencing base map data may include referencing an off board database.

In addition to one or more of the features described herein, referencing base map data may include referencing an on board database.

In addition to one or more of the features described herein, settling ego vehicle control points may include settling stop control points.

In addition to one or more of the features described herein, settling ego vehicle control points may include settling route waypoints

In another exemplary embodiment, a system for automated driving may include an ego vehicle having a GPS system providing ego vehicle coordinates, a base map database including predetermined attributes, and a controller. The controller may be configured to reference the base map database for predetermined attributes, settle ego vehicle control points based upon the predetermined attributes, and control at least one of a steering system, a braking system and a powertrain system based upon the ego vehicle control points.

In addition to one or more of the features described herein, the controller configured to settle ego vehicle control points may include the controller configured to arbitrate among the predetermined attributes to select a preferred one of the predetermined attributes and settle one ego vehicle control point based on the preferred one of the predetermined attributes.

In addition to one or more of the features described herein, the controller configured to arbitrate among the predetermined attributes may include the controller configured to evaluate existence and confidence levels of the predetermined attributes in a predetermined sequence and select a first acceptable predetermined attribute as the preferred one of the predetermined attributes.

In addition to one or more of the features described herein, the controller configured to arbitrate among the predetermined attributes may include the controller configured to evaluate existence and confidence levels of the predetermined attributes and select as the preferred one of the predetermined attributes the predetermined attribute having the highest confidence level.

In yet another exemplary embodiment, a method for automated driving may include receiving GPS coordinates of an ego vehicle, referencing base map data including predetermined attributes relevant to the GPS coordinates of the ego vehicle, the predetermined attributes including pavement markings, a sidewalk, a road edge curvature, an intersecting road segment, an intersection lane segment, and a perpendicular road edge, arbitrating among the predetermined attributes to select a preferred one of the predetermined attributes, settling an ego vehicle stop control point based on the preferred one of the predetermined attributes, and controlling at least one of a steering system, a braking system and a powertrain system to control the ego vehicle to the ego vehicle stop control point.

In addition to one or more of the features described herein, arbitrating among the predetermined attributes may include evaluating existence and confidence levels of the predetermined attributes in a predetermined sequence and selecting a first acceptable predetermined attribute as the preferred one of the predetermined attributes.

In addition to one or more of the features described herein, arbitrating among the predetermined attributes may include evaluating existence and confidence levels of the predetermined attributes and selecting as the preferred one of the predetermined attributes the predetermined attribute having the highest confidence level.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 illustrates an exemplary system for automated driving, in accordance with the present disclosure;

FIG. 2 illustrates an apparatus and method block diagram of an exemplary automated driving system, in accordance with the present disclosure;

FIG. 3 illustrates an exemplary driving scene described herein with respect to various scene features and base map attributes, in accordance with the present disclosure;

FIG. 4 illustrates an exemplary driving scene described herein with respect to various scene features and base map attributes, in accordance with the present disclosure;

FIG. 5 illustrates an exemplary driving scene described herein with respect to various scene features and base map attributes, in accordance with the present disclosure;

FIG. 6 illustrates an exemplary driving scene described herein with respect to various scene features and base map attributes, in accordance with the present disclosure;

FIG. 7 illustrates an exemplary driving scene described herein with respect to various scene features and base map attributes, in accordance with the present disclosure;

FIG. 8 illustrates an exemplary driving scene described herein with respect to various scene features and base map attributes, in accordance with the present disclosure;

FIG. 9 illustrates an exemplary driving scene described herein with respect to various scene features and base map attributes, in accordance with the present disclosure; and

FIG. 10 illustrates an exemplary driving scene described herein with respect to various scene features and base map attributes, in accordance with the present disclosure.

### DETAILED DESCRIPTION

The following description is merely exemplary in nature and is not intended to limit the present disclosure, its application or uses. Throughout the drawings, corresponding reference numerals indicate like or corresponding parts and features. As used herein, control module, module, control, controller, control unit, electronic control unit, processor and similar terms mean any one or various combinations of one or more of Application Specific Integrated Circuit(s) (ASIC), electronic circuit(s), central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, on vehicle controller area networks and in-plant and service-related networks. Functions of the control module as set forth in this disclosure may be performed in a distributed control architecture among several networked control modules. Software, firmware, programs, instructions, routines, code, algorithms and similar terms mean any controller executable instruction sets including calibrations, data structures, and look-up tables. A control module has a set of control routines executed to provide described functions. Routines are executed, such as by a central processing unit, and are operable to monitor inputs from sensing devices and other networked control modules and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests.

During roadway operation of a vehicle by a vehicle operator or through semi-automated or fully-automated controls, the vehicle may be an observer in an operational scene. An operational scene is generally understood to include substantially static elements including, for example, the roadway and surrounding infrastructure, and dynamic elements including, for example, other vehicles operating on the roadway. An observing vehicle may be referred to herein as a host vehicle or ego vehicle. Other participant vehicles sharing the roadway may be referred to as scene vehicles.

In accordance with the present disclosure, an ego vehicle may be capable of some level of automated driving. That is, an ego vehicle operator may delegate ego vehicle driving authority to an automated driving system which is capable of perceiving and understanding the ego vehicle scene and navigating the ego vehicle within a clear path using ego vehicle systems, for example, vehicle steering, braking and powertrain systems. Moreover, the automated driving system may be capable of understanding a desired destination and establishing routing for the ego vehicle that achieves the destination objective while considering preferences related to travel time, efficiency, and traffic congestion for example. The ego vehicle operator may be requested to regain control of the driving functions, for example when the ego vehicle lacks adequate information to continue driving authority.

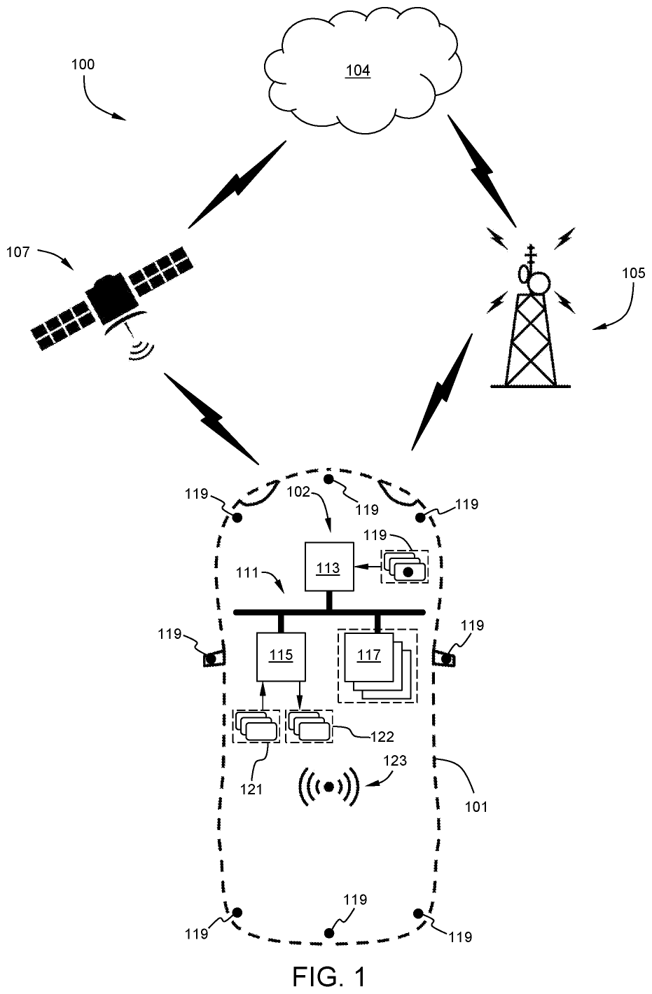

An ego vehicle may be equipped with various sensors and communication hardware and systems. An exemplary ego vehicle 101 is shown in FIG. 1 which illustrates an exemplary system 100 for automated driving, in accordance with the present disclosure. Ego vehicle 101 may include a control system 102 including a plurality of networked electronic control units (ECUs) which may be communicatively coupled via a bus structure 111 to perform control functions and information sharing, including executing control routines locally or in distributed fashion. Bus structure 111 may be a part of a Controller Area Network (CAN), or other similar network, as well known to those having ordinary skill in the art. One exemplary ECU in an internal combustion engine vehicle may include an engine control module (ECM) 115 primarily performing functions related to internal combustion engine monitoring, control and diagnostics based upon a plurality of inputs 121 and a plurality of outputs 122 for controlling engine related actuators. While inputs 121 are illustrated as coupled directly to ECM 115, the inputs may be provided to or determined within ECM 115 from a variety of well-known sensors, calculations, derivations, synthesis, other ECUs and sensors over the bus structure 111 as well understood by those having ordinary skill in the art. While outputs 122 are illustrated as coupled directly from ECM 115, the outputs may be provided over the bus structure 111 to actuators or other ECUs as well understood by those having ordinary skill in the art. Battery electric vehicles (BEV) may include a propulsion system control module primarily performing functions related BEV powertrain functions, including controlling wheel torque and electric charging and charge balancing of batteries within a battery pack. One having ordinary skill in the art recognizes that a plurality of other ECUs 117 may be part of the network of controllers onboard the ego vehicle 101 and may perform other functions related to various other vehicle systems (e.g. chassis, steering, braking, transmission, communications, infotainment, etc.). In the present embodiment, automated vehicle controls may encompass control of one or more vehicle systems affecting vehicle dynamics, for example a vehicle braking system including associated actuators, a vehicle steering system including associated actuators, and a powertrain system controlling wheel torque including associated actuators. A variety of vehicle related information may be commonly available and accessible to all networked ECUs, for example, vehicle dynamics information such as speed, heading, steering angle, multi-axis accelerations, yaw, pitch, roll, etc.

Another exemplary ECU may include an external object calculation module (EOCM) 113 primarily performing functions related to sensing the environment external to the ego vehicle 101 and, more particularly, related to roadway lane, pavement and object sensing. EOCM 113 receives information from a variety of sensors 119 and other sources. By way of example only and not of limitation, EOCM 113 may receive information from one or more perception systems including radar system, lidar system, ultrasonic system, vision system (e.g. cameras), global positioning system (GPS), vehicle-to-vehicle communication system, and vehicle-to-infrastructure communication systems, as well as from on board databases or off board databases, processing and information services (e.g. cloud resources 104), for example base map layers and routing services including crowd sourced navigation information. EOCM 113 may have access to ego vehicle position and velocity data, scene vehicle range and rate data, and vision based data which may be useful in the determination or validation of roadway and scene vehicle information, for example, roadway features and scene vehicle geometric, distance and velocity information. Vision systems are particularly useful in conjunction with trained neural networks in segmenting images and extracting and classifying objects and roadway features and assigning attributes. Sensors 119 may be positioned at various perimeter points around the vehicle including front, rear, corners, sides etc. as shown in the ego vehicle 101. Other positioning of sensors is envisioned and may include forward-looking sensors through the vehicle windshield, for example mounted in front of a rear-view mirror or integrated within such a mirror assembly. Sensor 119 positioning may be selected as appropriate for providing the desired coverage for particular applications. For example, front and front corner positioning, and otherwise front facing of sensors 119 may be more preferred with respect to situational awareness during forward travel, in accordance with the present disclosure. It is recognized, however, that analogous placement at the rear or rear facing of sensors 119 may be more preferred with respect to situational awareness during reverse travel. While sensors 119 may be coupled directly to EOCM 113, the inputs may be provided to EOCM 113 over the bus structure 111 as well understood by those having ordinary skill in the art. Ego vehicle 101 may be equipped with radio communication capabilities shown generally at 123 and more particularly related to GPS satellite 107 communications, vehicle-to-vehicle (V2V) communications, and vehicle-to-infrastructure (V2I) communications such as with terrestrial radio towers 105. The description herein of the exemplary system 100 for is not intended to be exhaustive. Nor is the description of the various exemplary system to be interpreted as being wholly required. Thus, one having ordinary skill in the art will understand that some, all, and additional technologies from the described exemplary system 100 may be used in various implementations of methods and apparatus in accordance with the present disclosure.

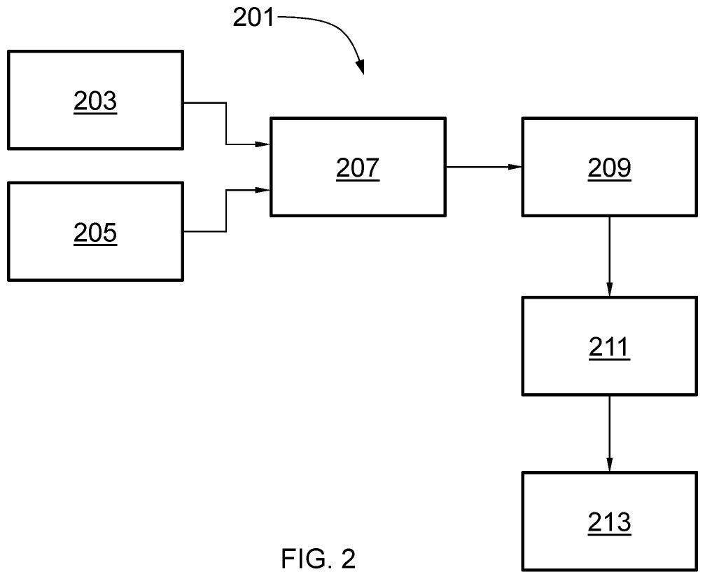

FIG. 2 illustrates an apparatus and method block diagram of an exemplary automated driving system 201 for an ego vehicle as described herein including EOCM 113 and associated perception systems, GPS and databases. The automated driving system 201 may include perception block 203 and mapping block 205. The perception block 203 may include EOCM 113 and associated sensors perceiving the environment external to the ego vehicle 101. For example, perception block may, from vision systems, perceive objects, roads, and related landmarks and features generally forward of the ego vehicle. More particularly, perception block may be configured to classify features and assign attributes of a scene useful to the automated driving system including road geometry such as lane and road boundaries, edges, and curvature, traffic signals and signage, pavement markings, and other static and dynamic scene objects. Mapping block 205 may also include EOCM 113 and corresponding vision system for developing real time mapping information from classified features and attributes. The mapping block 205 may also include GPS hardware and information and scene relevant base map information from on board or off board resources. In accordance with one embodiment, scene relevant base map information may include map attributes useful to the automated driving system including road geometry such as: lane and road boundaries, edges, centerlines and curvature; traffic signals and signage; pavement markings; and other static map attributes. Such map layer information and attributes may be predetermined from terrestrial road mapping services and/or aerial images and includes driving scene image classification of relevant map attributes related to roadway lane, pavement, and object sensing. Information from the perception block 203 and mapping block 205 is arbitrated to determine control points along the ego vehicle route by localization block 207. Control points from the localization block 207 may be provided to a planning block 209 which settles the control points relative to appropriate scene static map layers on the navigation path to be followed and provides a trajectory plan to control block 211 accounting for road geometry, speed limits, map attributes and other considerations. Control block 211 issues control signals for actuation and control of one or more ego vehicle systems 213, for example, vehicle steering, braking and powertrain systems.

In accordance with the present disclosure, control points may include stop control points for intersections which may be recognized as a point coincident with pavement marking stop line or yield line. An intersection as used herein may include an intersecting or merging of two or more roads or lanes. Stop maneuvers are desirable when the intersection is designated as a stop controlled intersection. Similarly, yield maneuvers are desirable when the intersection is designated as a yield controlled intersection. In accordance with the present disclosure, both stop controlled intersections and yield controlled intersections require substantially similar vehicle operating profiles (i.e. deceleration to perform a stop maneuver). Therefore, it is understood that stop control references herein may also refer to yield control. Stop controlled intersections may be characterized by one or more of a signal light, stop or yield sign, or stop line or yield line pavement markings. Stop control points may be settled by the perception block 203 at a point at a pavement marking stop line or yield line attribute determined from the perception block 203. However, perception block 203 may not determine a stop line or yield line attribute at an intersection for various reasons, including poor image quality, poor lighting and shadows, poor visibility, worn pavement markings, lack of pavement markings, indeterminate or low confidence classifications, etc. Thus, the perception system may be indeterminate with respect to attributes needed for determination of a stop control point. In such situations, perception block 203 may still determine an attribute indicating an intersection and/or GPS and map layer information may determine an intersection including a stop controlled intersection. However, absent determination and settlement of a stop control point by perception block 203, such situations may require surrender of driving authority to the ego vehicle operator. In one embodiment, where perception block 203 is indeterminate with respect to a stop line or yield line and hence no associated stop control point is determinable, an alternative stop control point determination may be made based on map layer data to the exclusion of perception block 203. Reference to base map attribute data may include scene relevant map data determined in accordance with GPS coordinates of the ego vehicle 101. One skilled in the art will appreciate that the above description and the following examples are made with respect to stop control points. However, the present disclosure is not limited to such control points and it is envisioned that the present disclosure may also be applied to other control points such as route waypoints. Therefore, perception system being indeterminate with respect to attributes needed for determination of a route waypoint control point may similarly benefit from an alternative route waypoint control point determination based on map layer data to the exclusion of perception block 203.

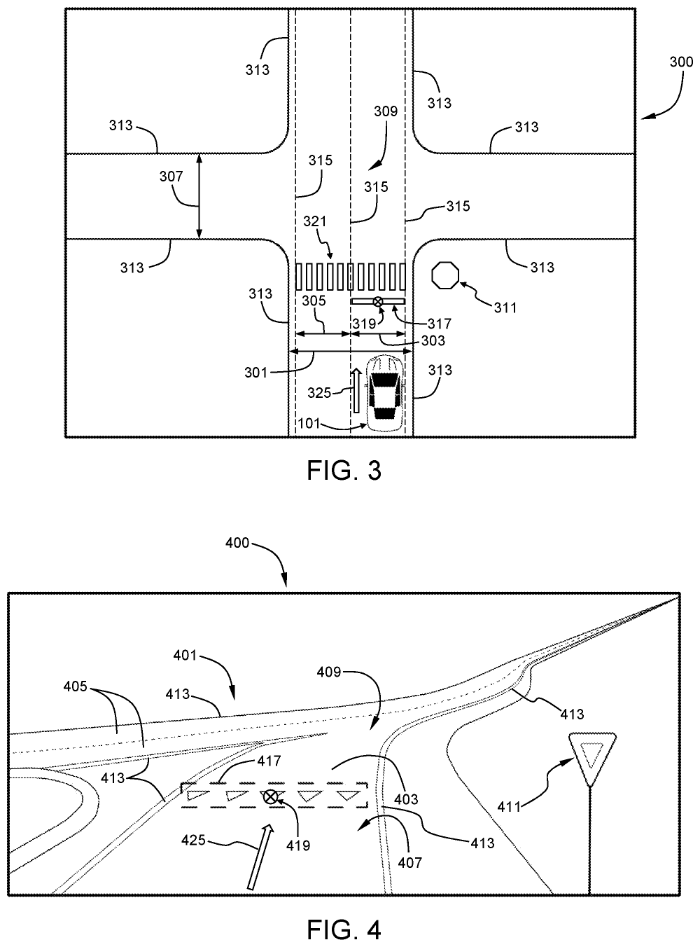

FIGS. 3-10 illustrate a plurality of driving scenes including a variety of available attributes wherein map based stop point control may be employed to maintain automated driving system control of the ego vehicle at stop controlled intersections. FIGS. 3-10 present scenes which may account for many scene categories based on intersection related attributes of a base map which may be accessed in relation to GPS location coordinates of the ego vehicle 101 during a temporal approach to a stop controlled intersection with a corresponding base map stop attribute such as a signal light, stop or yield sign, or pavement marking. As previously described, such base map information may be predetermined from terrestrial road mapping services and/or aerial images and may include driving scene image classifications identifying relevant map attributes indicative of a desired stop maneuver, such as a signal light, stop or yield signage, or pavement markings. Additionally, the base map may include a variety of attributes useful in derivation of stop control points, for example crosswalk pavement markings, sidewalks, curb drops (e.g., curb ramps or openings), road edges including curvatures, lane boundaries, intersection roads boundaries, and perpendicular travel lane edges. These base map attributes are discussed further herein with respect to arbitration of hierarchical prioritizations.

FIG. 3 illustrates an exemplary driving scene 300 described with respect to various scene features and base map attributes. Ego vehicle 101 is shown travelling on a first road segment 301. The first road segment 301 may include one or more lanes. In the example, ego vehicle 101 is travelling in direction 325 and occupying travel lane 303 which is adjacent to lane 305. Lane 305 may carry traffic in the same or opposite direction to direction 325. A second road segment 307 crosses the first road segment 301 forming an intersection 309. Intersection 309 is a stop controlled intersection as designated by stop sign 311. Each road segment 301, 307 has respective road boundaries 313. Each lane segment 303, 305 similarly has respective lane boundaries 315. Road segment 301 may have a crosswalk pavement marking 321 and stop line pavement marking 317 associated with the intersection 309. A desired stop control point 319 may be coincident with the stop line 317, nominally at a lateral midpoint of the travel lane segment 303. The base map may include at intersection 309 a stop line attribute including location coordinates useful in determination of a coincident stop control point 319. Other attributes as discussed herein may be associated with stop controlled intersections, including the exemplary intersection 309 of driving scene 300, useful in the determination of stop control points.

FIG. 4 illustrates an exemplary driving scene 400 described with respect to various scene features and base map attributes. The first road segment 401 may include one or more lane segments 405. In the example, an ego vehicle is travelling in direction 425 and occupying a second road segment 407 which is a merge lane segment 403 feeding into road segment 401. The first road segment 401 and the merge lane segment 403 second road segment 407 together form and intersection 409. Intersection 409 is a stop controlled intersection as designated by a yield sign 411. Each road segment 401, 407 has respective road boundaries 413. Each lane segment 403, 405 similarly has respective lane boundaries inwardly adjacent the road boundaries 413. Second road segment 407 may have a yield line pavement marking 417 associated with the intersection 409. A desired stop control point 419 may be coincident with the yield line 417, nominally at a lateral midpoint of the merge lane segment 403. The base map may include at intersection 409 a yield line attribute including location coordinates useful in determination of a coincident stop control point 419. Other attributes as discussed herein may be associated with stop controlled intersections, including the exemplary intersection 409 of driving scene 400, useful in the determination of stop control points.

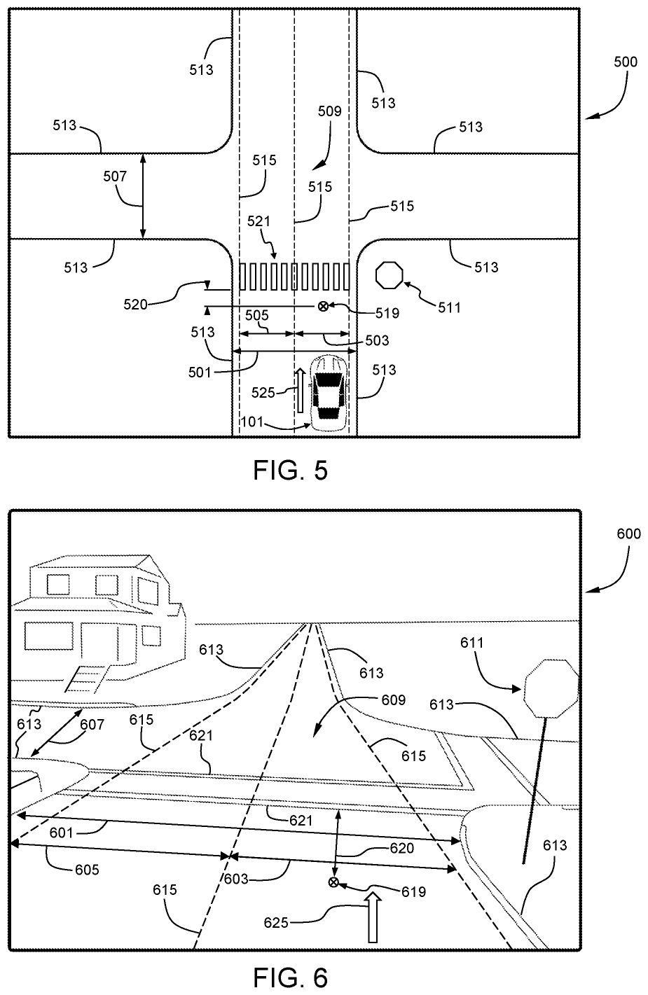

FIG. 5 illustrates an exemplary driving scene 500 described with respect to various scene features and base map attributes. Ego vehicle 101 is shown travelling on a first road segment 501. The first road segment 501 may include one or more lanes. In the example, ego vehicle 101 is travelling in direction 525 and occupying travel lane 503 which is adjacent to lane 505. Lane 505 may carry traffic in the same or opposite direction to direction 525. A second road segment 507 crosses the first road segment 501 forming an intersection 509. Intersection 509 is a stop controlled intersection as designated by stop sign 511. Each road segment 501, 507 has respective road boundaries 513. Each lane segment 503, 505 similarly has respective lane boundaries 515. Road segment 501 may have a crosswalk pavement marking 521 but is lacking a stop line pavement marking associated with the intersection 509 or confidence in such an attribute is insufficient. A desired stop control point 519 may be settled nominally at a lateral midpoint of the travel lane segment 503 at a predetermined distance 520 preceding the approach relative to the crosswalk pavement marking 521. The base map may include at intersection 509 a crosswalk attribute including location coordinates useful in determination of a stop control point 519. Other attributes as discussed herein may be associated with stop controlled intersections, including the exemplary intersection 509 of driving scene 500, useful in the determination of stop control points.

FIG. 6 illustrates an exemplary driving scene 600 described with respect to various scene features and base map attributes. An ego vehicle is assumed travelling on a first road segment 601. The first road segment 601 may include one or more lanes. In the example, the ego vehicle is travelling in direction 625 and occupying travel lane 603 which is adjacent to lane 605. Lane 605 may carry traffic in the same or opposite direction to direction 625. A second road segment 607 crosses the first road segment 601 forming an intersection 609. Intersection 609 is a stop controlled intersection as designated by stop sign 611. Each road segment 601, 607 has respective road boundaries 613. Each lane segment 603, 605 similarly has respective lane boundaries 615. Road segment 601 may have a crosswalk pavement marking 621 but is lacking a stop line pavement marking associated with the intersection 609 or confidence in such an attribute is insufficient. A desired stop control point 619 may be settled nominally at a lateral midpoint of the travel lane segment 603 at a predetermined distance 620 preceding the approach relative to the crosswalk pavement marking 621. The base map may include at intersection 609 a crosswalk attribute including location coordinates useful in determination of a stop control point 619. Other attributes as discussed herein may be associated with stop controlled intersections, including the exemplary intersection 609 of driving scene 600, useful in the determination of stop control points.

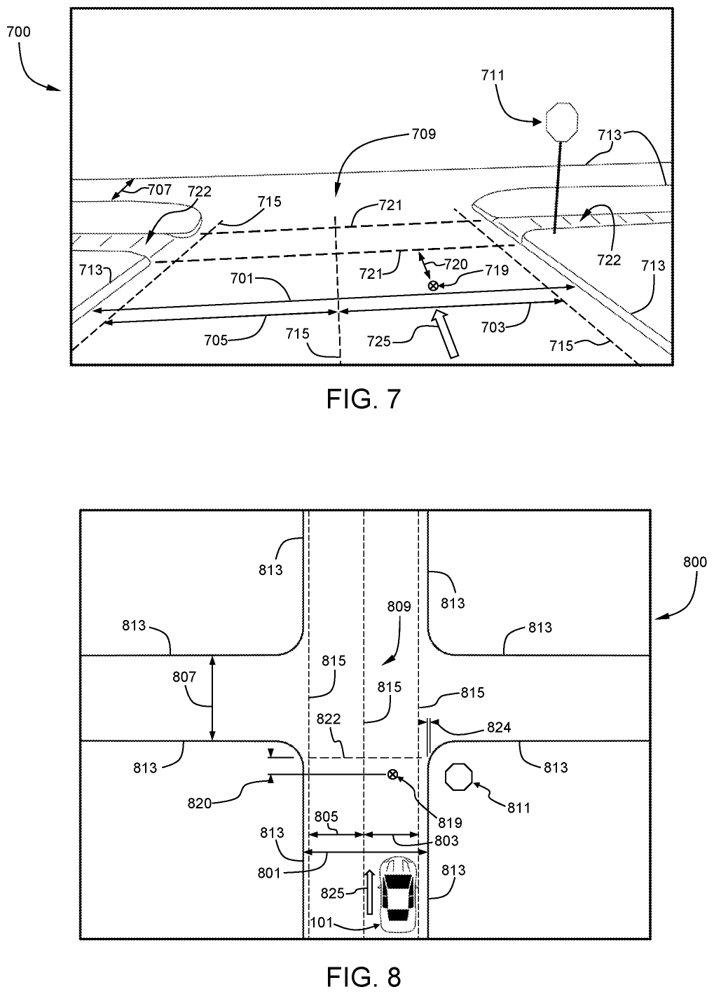

FIG. 7 illustrates an exemplary driving scene 700 described with respect to various scene features and base map attributes. An ego vehicle is assumed travelling on a first road segment 701. The first road segment 701 may include one or more lanes. In the example, the ego vehicle is travelling in direction 725 and occupying travel lane 703 which is adjacent to lane 705. Lane 705 may carry traffic in the same or opposite direction to direction 725. A second road segment 707 crosses the first road segment 701 forming an intersection 709. Intersection 709 is a stop controlled intersection as designated by stop sign 711. Each road segment 701, 707 has respective road boundaries 713. Each lane segment 703, 705 similarly has respective lane boundaries 715. Road segment 701 has no pavement markings or confidence in such attributes are insufficient. However, a sidewalk 722 is present and a crosswalk location 721 may be inferred from the sidewalk 722 location. A desired stop control point 719 may be settled nominally at a lateral midpoint of the travel lane segment 703 at a predetermined distance 720 preceding the approach relative to the inferred crosswalk location 721. The base map may include at intersection 709 sidewalk attribute including location coordinates useful in inferring a crosswalk location 721 and determination of a stop control point 719. Other attributes as discussed herein may be associated with stop controlled intersections, including the exemplary intersection 709 of driving scene 700, useful in the determination of stop control points.

FIG. 8 illustrates an exemplary driving scene 800 described with respect to various scene features and base map attributes. Ego vehicle 101 is shown travelling on a first road segment 801. The first road segment 801 may include one or more lanes. In the example, ego vehicle 101 is travelling in direction 825 and occupying travel lane 803 which is adjacent to lane 805. Lane 805 may carry traffic in the same or opposite direction to direction 825. A second road segment 807 crosses the first road segment 801 forming an intersection 809. Intersection 809 is a stop controlled intersection as designated by stop sign 811. Each road segment 801, 807 has respective road boundaries 813. Each lane segment 803, 805 similarly has respective lane boundaries 815. Road segment 801 has no pavement markings and no sidewalks or other attribute of sufficient confidence to infer a crosswalk location. However, a curvature connecting, returning or otherwise transitioning the second road segment 807 to the first road segment 801 is present. In one embodiment, a reference point on the curvature that deviates laterally by a predetermined distance 824 from the road boundary 813 adjacent the ego vehicle in approaching the intersection 809 may be determined from a road curvature attribute which is understood to include any attribute representing the change in curvature. A reference line 822 perpendicular to the travel lane 803 direction and passing through the reference point on the curvature may be determined. A desired stop control point 819 may be settled nominally at a lateral midpoint of the travel lane segment 803 at a predetermined distance 820 preceding the approach relative to the reference line 822. The base map may include at intersection 809 road edge and curvature attributes including location coordinates useful in determination of a stop control point 819. Other attributes as discussed herein may be associated with stop controlled intersections, including the exemplary intersection 809 of driving scene 800, useful in the determination of stop control points.

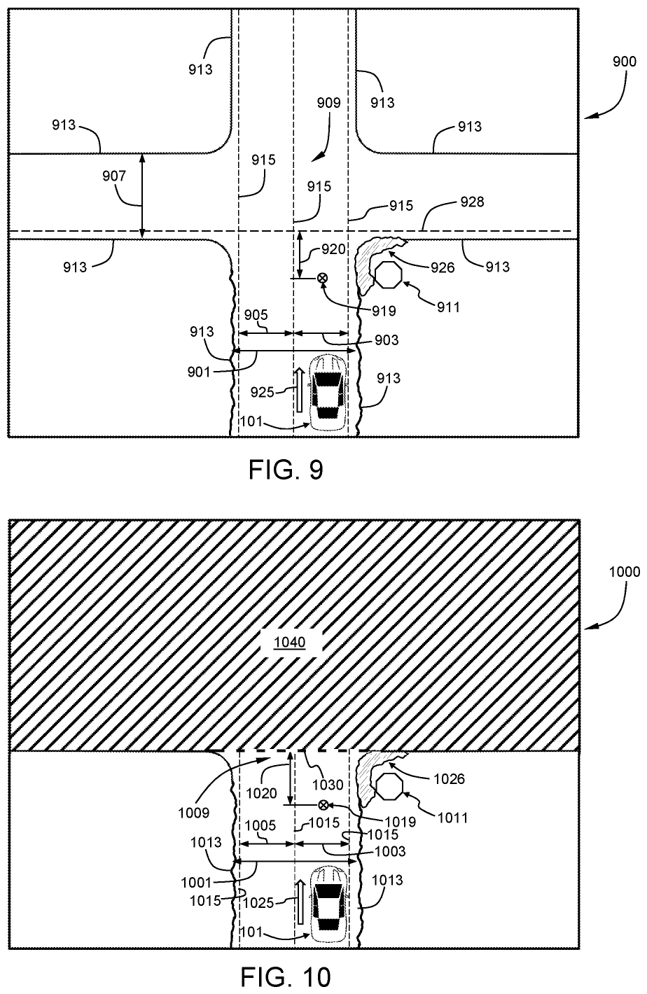

FIG. 9 illustrates an exemplary driving scene 900 described with respect to various scene features and base map attributes. Ego vehicle 101 is shown travelling on a first road segment 901. The first road segment 901 may include one or more lanes. In the example, ego vehicle 101 is travelling in direction 925 and occupying travel lane 903 which is adjacent to lane 905. Lane 905 may carry traffic in the same or opposite direction to direction 925. A second road segment 907 crosses the first road segment 901 forming an intersection 909. Intersection 909 is a stop controlled intersection as designated by stop sign 911. Each road segment 901, 907 has respective road boundaries 913. Each lane segment 903, 905 similarly has respective lane boundaries 915. Road segment 901 has no pavement markings and no sidewalks or other attribute of sufficient confidence to infer a crosswalk location. Moreover, road edges may be so poorly defined, including curvatures transitioning the first road segment 901 to the second road segment 907, that the base map does not include such attributes or such attributes are of insufficient confidence. For example, on rural or ill maintained roadways, soft shoulders may be common and vegetation encroachment, puddle formation 926, and edge erosion may result in low confidence in edge discernment and corresponding base map attribute data. However, the intersecting road segment 907 or corresponding lane segment(s) may provide an intersecting segment line 928 intersecting the road segment 901 or lane segment(s) 903, 905. The intersecting segment line 928 may correspond to a road segment 907 centerline or road boundaries 913, to lane segment centerlines or lane boundaries 915, or to any other similarly relevant intersecting road or lane attribute. In one embodiment, intersecting segment line 928 may provide a reference perpendicular to the travel lane 903. A desired stop control point 919 may be settled nominally at a lateral midpoint of the travel lane segment 903 at a predetermined distance 920 preceding the approach relative to the intersecting segment line 928. In one embodiment, the predetermined distance 920 may be determined in relation to the intersecting road segment 907 local speed limit attribute or roadway functional class attribute wherein higher speed limits or a higher functional class designation may result in a greater setback of the stop control point. The base map may include at intersection 909 an intersection segment attribute including location coordinates of road and lane features useful in determination of a stop control point 919. Other attributes as discussed herein may be associated with stop controlled intersections, including the exemplary intersection 909 of driving scene 900, useful in the determination of stop control points.

FIG. 10 illustrates an exemplary driving scene 1000 described with respect to various scene features and base map attributes. Ego vehicle 101 is shown travelling on a first road segment 1001. The first road segment 1001 may include one or more lanes. In the example, ego vehicle 101 is travelling in direction 1025 and occupying travel lane 1003 which is adjacent to lane 1005. Lane 1005 may carry traffic in the same or opposite direction to direction 1025. The crosshatched area represents a substantially unmapped region 1040 or a region of low attribute confidence. Thus, while the unmapped region 1040 may include traversable roadways, insufficient reliable map data is available regarding its intersection with first road segment 1001, for example intersecting road segment data. Intersection 1009 is a stop controlled intersection as designated by stop sign 1011. Road segment 1001 has road boundaries 1013. Each lane segment 1003, 1005 similarly has respective lane boundaries 1015. Road segment 1001 has no pavement markings and no sidewalks or other features sufficient to infer a crosswalk location. Moreover, road edges may be so poorly defined, including curvatures transitioning the first road segment 1001 to any intersecting road segment, that the base map does not include such attributes. For example, on rural or ill maintained roadways, soft shoulders may be common and vegetation encroachment, puddle formation 1026, and edge erosion may result in low confidence in edge discernment and corresponding base map attribute data. Moreover, the no reliable intersecting road segment or corresponding lane segment(s) provide an intersecting segment line intersecting the road segment 1001 or lane segment(s) 1003, 1005. Thus, in accordance with the present embodiment, the furthest perpendicular road edge attribute 1030 corresponding to the first road segment 1001 or lane segment(s) 1003, 1005 is used to provide a reference perpendicular to the travel lane 1003. A desired stop control point 1019 may be settled nominally at a lateral midpoint of the travel lane segment 1003 at a predetermined distance 1020 preceding the approach relative to the perpendicular road edge attribute 1030. The base map may include at intersection 1009 a perpendicular road edge attribute 1030 including location coordinates useful in determination of a stop control point 1019. Other attributes as discussed herein may be associated with stop controlled intersections, including the exemplary intersection 1009 of driving scene 1000, useful in the determination of stop control points.

The automated driving system 201 of ego vehicle 101, in approach to stop controlled intersections, may query base map data including attributes as described above. More particularly, where the ego vehicle 101 perception block 203 of the automated driving system 201 is compromised or otherwise unable to reliably determine and settle a stop control point, the automated driving system 201 may access base map data attributes and arbitrate among the predetermined map based attributes. Such arbitration may be in accordance with a hierarchical prioritization as substantially set forth in sequence above. Thus, in one embodiment, priority of base map attributes is as follows: stop line or yield line location; crosswalk location; travel road edge curvature; intersecting road or lane segment; and perpendicular road edge. A first acceptable attribute encountered may then be further utilized in the determination of a stop control point. Alternatively, arbitration among the predetermined attributes from the map data may be in accordance with a highest confidence level ranking of all predetermined attributes. Other arbitration schemes may be apparent to one having ordinary skill in the art and the ones disclosed herein are made by way of non-limiting examples. Similarly, additional or different attributes may be apparent to one having ordinary skill in the art and may be developed for inclusion in base map data for purposes primarily or additionally related to map based stop control point determination. It is envisioned that stop points may themselves be included in base map data as independent attributes requiring simplified reference based, for example, on GPS location and stop controlled intersection approach direction.

Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

It should be understood that one or more steps within a method or process may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method for automated driving, comprising:
real time mapping driving scene attributes with an ego vehicle perception system and settling ego vehicle control points based upon the real time mapping;
when real time mapping is indeterminate with respect to scene attributes needed for settling ego vehicle control points, referencing base map data for predetermined attributes and settling ego vehicle control points based upon the predetermined attributes from the base map data; and
controlling at least one of a steering system, a braking system and a powertrain system to control the ego vehicle to the ego vehicle control points.

2. The method of claim 1, wherein referencing base map data for predetermined attributes comprises referencing base map data relevant to GPS coordinates of the ego vehicle.

3. The method of claim 1, wherein settling ego vehicle control points based upon the predetermined attributes from the base map data comprises arbitrating among the predetermined attributes to select a preferred one of the predetermined attributes and settling one ego vehicle control point based on the preferred one of the predetermined attributes.

4. The method of claim 3, wherein arbitrating among the predetermined attributes comprises evaluating existence and confidence levels of the predetermined attributes in a predetermined sequence and selecting a first acceptable predetermined attribute as the preferred one of the predetermined attributes.

5. The method of claim 3, wherein arbitrating among the predetermined attributes comprises evaluating existence and confidence levels of the predetermined attributes and selecting as the preferred one of the predetermined attributes the predetermined attribute having the highest confidence level.

6. The method of claim 1, wherein the predetermined attributes comprise pavement markings, a sidewalk, a road edge curvature, an intersecting road segment, an intersection lane segment, and a perpendicular road edge.

7. The method of claim 6, wherein pavement markings comprise a stop line, a yield line and a crosswalk.

8. The method of claim 1, wherein the ego vehicle perception system comprises a vision system.

9. The method of claim 8, wherein the ego vehicle perception system further comprises at least one of a radar system, a lidar system, and an ultrasonic system.

10. The method of claim 1, wherein referencing base map data comprises referencing an off board database.

11. The method of claim 1, wherein referencing base map data comprises referencing an on board database.

12. The method of claim 1, wherein settling ego vehicle control points comprises settling stop control points.

13. The method of claim 1, wherein settling ego vehicle control points comprises settling route waypoints.

14. A system for automated driving, comprising:
an ego vehicle comprising a GPS system providing ego vehicle coordinates;
a base map database comprising predetermined attributes;
a controller configured to:
reference the base map database for predetermined attributes;
settle ego vehicle control points based upon the predetermined attributes; and
control at least one of a steering system, a braking system and a powertrain system based upon the ego vehicle control points.

15. The system of claim 14, wherein the controller configured to settle ego vehicle control points comprises the controller configured to arbitrate among the predetermined attributes to select a preferred one of the predetermined attributes and settle one ego vehicle control point based on the preferred one of the predetermined attributes.

16. The system of claim 15, wherein the controller configured to arbitrate among the predetermined attributes comprises the controller configured to evaluate existence and confidence levels of the predetermined attributes in a predetermined sequence and select a first acceptable predetermined attribute as the preferred one of the predetermined attributes.

17. The system of claim 15, wherein the controller configured to arbitrate among the predetermined attributes comprises the controller configured to evaluate existence and confidence levels of the predetermined attributes and select as the preferred one of the predetermined attributes the predetermined attribute having the highest confidence level.

18. A method for automated driving, comprising:
receiving GPS coordinates of an ego vehicle;
referencing base map data including predetermined attributes relevant to the GPS coordinates of the ego vehicle, the predetermined attributes comprising pavement markings, a sidewalk, a road edge curvature, an intersecting road segment, an intersection lane segment, and a perpendicular road edge;
arbitrating among the predetermined attributes to select a preferred one of the predetermined attributes;
settling an ego vehicle stop control point based on the preferred one of the predetermined attributes; and
controlling at least one of a steering system, a braking system and a powertrain system to control the ego vehicle to the ego vehicle stop control point.

19. The method of claim 18, wherein arbitrating among the predetermined attributes comprises evaluating existence and confidence levels of the predetermined attributes in a predetermined sequence and selecting a first acceptable predetermined attribute as the preferred one of the predetermined attributes

20. The method of claim 18, wherein arbitrating among the predetermined attributes comprises evaluating existence and confidence levels of the predetermined attributes and selecting as the preferred one of the predetermined attributes the predetermined attribute having the highest confidence level.
